(19) United States
(12) Patent Application Publication
(10) Pub. No.: US 2006/0024583 A1
(43) Pub. Date: Feb. 2, 2006

(54) Nickel hydroxide impregnated carbon foam electrodes for rechargeable nickel batteries

(75) Inventors: Alamjeet Singh, Uttar Pradesh (IN); Bahne Cornilsen, Houghton, MI (US); Michael E. Mullins, Houghton, MI (US); Tony N. Rogers, Houghton, MI (US)

Correspondence Address: MICHAEL BEST & FRIEDRICH, LLP, 100 E WISCONSIN AVENUE, MILWAUKEE, WI, 53202, US

(73) Assignee: Board of Control of Michigan Technological University, Houghton, MI (US)

(21) Appl. No.: 11/182,891

(22) Filed: Jul. 15, 2005

Related U.S. Application Data
(60) Provisional application No. 60/588,108, filed on Jul. 15, 2004.

(51) Int. Cl. H01M 4/66; H01M 4/52; B05D 5/12

(52) U.S. Cl. 429/245; 429/223; 427/126.6

(57) ABSTRACT

A novel nickel-carbon electrode, and methods for making the same, have been developed. The nickel-carbon electrode comprises an active mass (e.g., a nickel oxyhydroxide, hydroxide or oxide) deposited to a carbon foam using any one of chemical deposition, thermal deposition or electrochemical deposition. The nickel-carbon electrode is formed or “activated” through a series of charge-discharge cycles. The nickel-carbon electrode is comparable in volumetric capacities (mAh/cc) with commercial nickel electrodes but higher in gravimetric capacities (mAh/g). The nickel-carbon electrode may be used in rechargeable nickel-based batteries which have applications in cordless appliances, portable devices, standby power systems, the aerospace industry, and hybrid electric vehicles.

### CROSS-REFERENCE TO RELATED APPLICATION

This application claims priority under 35 U.S.C. §119(e) to U.S. Provisional Application No. 60/588,108 filed Jul. 15, 2004, the entire content of which is hereby incorporated by reference.

### FIELD OF INVENTION

The present invention relates to nickel electrodes and methods for making the same. More particularly, the invention relates to nickel electrodes that may be used in rechargeable nickel-based batteries.

### BACKGROUND OF THE INVENTION

Nickel-based batteries have their origins in the Ni—Cd battery, first developed in 1899 by Waldemar Junger in Sweden, and the Ni—Fe battery, first developed in 1901 by Thomas A. Edison in the United States. These batteries contained a nickel hydroxide cathode, cadmium or iron anodes, and an aqueous potassium hydroxide electrolyte. Ni—Cd batteries dominated the battery industry for many years due to a broad temperature range of operation, long storage life, high cycle life, and low maintenance. Two other important attributes are a fairly constant discharge voltage and high rate discharge capability. During the last few decades, a number of new nickel-based battery systems have been developed, including the Ni—H₂ battery, the Ni—Zn battery and the Ni-metal hydride battery. Nickel batteries have widespread application in cordless appliances, portable devices, standby power systems, and electric vehicles, in particular, hybrid electric vehicles. Other applications include aerospace and satellite applications in which the batteries must operate at low temperatures.

Although nickel-based batteries exhibit significant advantages over other battery systems, they also exhibit several disadvantages. Some nickel-based batteries, particularly the Ni—Cd batteries can create environmental problems if not disposed of properly. Nickel-based batteries are typically expensive to manufacture, in part, because of cobalt additives, but also because of the nickel itself, both in the active mass and in the current collectors. The replacement of cadmium with hydrogen and metal hydrides to increase capacity and to eliminate the cadmium disposal problem also contributes to increased costs. Nickel-based batteries are also relatively heavy, and will be even more suitable for portable devices, hybrid electric vehicles, and aerospace applications if they can be made lighter.

The positive electrode for all nickel-based battery systems is the nickel electrode. The efficiency of these batteries greatly depends on the properties of this cathode. The early Junger and Edison electrodes consisted of nickel hydroxide powder pressed into the pockets of a metal plate. All commercial nickel electrodes are made by applying active mass (e.g., nickel hydroxide or nickel oxyhydroxide) to a conductive support. These supports serve both as current collectors and physical retainers which contain and hold the active material in place. Several different support systems have been devised in attempts to optimize the performance of the nickel electrode, and several active mass application methods have been developed. Some of the commercially available electrodes are summarized below.

Pocket electrodes were one of the first types of nickel electrodes produced. Perforated iron or steel sheets are electroplated with nickel, and pockets are filled with active mass and powdered graphite to improve conduction. These are cheaper, per amp-hour, than other electrodes, but have a lower energy density.

Tubular electrodes were designed by Edison in the 1900's and comprised tubular plates in which perforated nickel tubes were embedded with a mixture of active mass and nickel flakes. The nickel flakes acted as a conducting agent. Low energy density and high manufacturing cost have virtually eliminated these electrodes from the market.

Pressed electrodes are made by cold-pressing an active mass in the form of thin tablets onto either nickel-wire gauze or microporous nickel. The guaze of the microporous nickel acts as a current collector and improves strength. Nickel powder (i.e., carbonyl nickel) is also added to improve the conductivity. These electrodes are primarily used in button cells for watches and hearing aids.

Sintered electrodes were first developed and patented in 1928 in Germany. The active mass support and current collector is a sintered nickel powder. These are probably the most popular and commonly used support for nickel batteries, in particular the aerospace cells. These are manufactured by sintering carbonyl nickel powder onto a wire screen at 1000° C. in a reducing atmosphere to avoid oxidation of the nickel powder. This porous sinter, commonly referred to as a plaque, supports the nickel electrode active mass which is deposited within the pores of this plaque. These electrodes can be made of varying thickness. Normally, 0.5 mm to 1 mm sintered electrodes are used commercially. Sintered electrodes have better mechanical strength, high porosity, and large pore volumes, providing optimal incorporation of active mass. This provides more current capacity and higher rates of discharge compared to other electrodes. Although sintered electrodes have high efficiencies and widespread applications, their high cost and weight have been a big disadvantage. Many novel electrode structures have been developed attempting to overcome these drawbacks.

Fiber electrodes, also called composite nickel electrodes, are lighter in weight and more flexible, as compared with sintered electrodes. Organic fibers are coated with a thin (0.6 to 0.8 μm) nickel layer. These coated layers are sintered and heated to burn off the organics. The performance of these electrodes is reported to vary linearly with electrode thickness. Expansion during cycling may be a problem with these because the active mass is not rigidly contained.

Woven cloth electrodes were developed in Britain in the early 1970's. A woven cloth, which has good strength and flexibility, is converted into a porous nickel replica by immersing it in nickel chloride hexahydrate solution and subsequently heating. The nickel chloride is reduced and the resulting nickel sinters. Several such layers are stacked and re-sintered to give an electrode of the required thickness. Although these electrodes have lighter weight and good strength, they have poorer current capacity compared to sintered electrodes.

Foam-based nickel electrodes provide high specific energies (mA/cm³). Urethane resins are foamed and nickel-plated by electrolysis or chemical vapor deposition, then heat treated to burn off the urethane. This leaves a nickel skeleton of high porosity and strength. Active mass is pasted into this foam structure and dried.

Controlled-micro-geometry electrodes, also called CMG electrodes, are made by coating porous nickel hydroxide on thin perforated nickel foils (about 4 μm thick). Numbers of these foils are stacked such that their perforations form a continuous passage through the plate. These electrodes swell during cycling, which can cause temporary loss of capacity.

In addition to the above, nickel felt, nickel-plated graphite, nickel-plated plastic, etc. have been used as conductive holders or supports for the active mass.

### DEFINITIONS

Whenever used in this specification, the terms set forth shall have the following meanings:

“Active mass” shall mean electroactive material in and/or on the electrode support that provides the cathodic electrochemical reaction during battery operation. The active mass may comprise a non-stoichiometric or stoichiometric nickel hydroxide, or a non-stoichiometric or stoichiometric nickel oxyhydroxide, or a combination thereof.

“Additive” shall mean a substance added to another substance or material to improve its properties in some way. Additives to the nickel cathode may comprise transition metals, lanthanide group metals, or a combination thereof added to the active mass as cations or as metals to enhance the electrochemical properties of the electrode.

“Carbonaceous substrate” shall mean a substrate comprising carbon. The carbon can be in amorphous form (e.g., amorphous carbons such as carbon black and charcoal), a crystalline form (e.g., graphite, diamond and fullerene), or a combination thereof. The carbonaceous substrate may comprise carbon foam.

“Counter electrode” shall mean the electrode used to complete the electrical circuit with the working electrode, within the cell and through the electrolyte. This counter is the negative electrode, or anode, relative to the Ni cathode, working electrode.

“Current collector” shall mean a structural part of an electrode assembly whose primary purpose is to conduct electricity between the actual working (or reacting) part of the electrode, i.e., the Ni electrode active mass, and the terminals of an electrochemical cell.

“Electrode capacity” shall mean the energy delivered by an electrode during discharge. In quantitative terms, the capacity may be expressed as “C_{Wh}”, the “watt hour” (Wh) capacity. Often it is easier and sufficient to measure the current output of the electrode expressed as “C_{Ah}”, the “amp hour” (Ah) capacity. In laboratory work where the electrode is discharged at constant current, “C_{Ah}” is equal to the product of the discharge current and the discharge time.

“Electrode charging” shall mean the process of electrically storing energy in an electrode. The electrodes can be charged either at constant current or under controlled potential. The amount of charge delivered is measured as the product of current applied and the charging time.

“Electrode discharging” shall mean the process of electrically utilizing the current stored in an electrode. Discharging may also be done at constant current, across a fixed resistance, or under a controlled voltage, depending on the system requirement.

“Electrode efficiency” shall mean either the ampere-hour efficiency, η_{AB}, or watt-hour efficiency, η_{Wh}, as determined by the expressions below.

$${η}_{Ah} = \frac{Available capacity in Ah}{Required charge input in Ah}$$

$${η}_{Wh} = \frac{Available energy in Wh}{Required energy input in Wh}$$

“Gravimetric capacity” shall mean the discharge capacity per unit mass of active material, or of total electrode mass (Ah/g).

“Half-life of the electrode” shall mean the number of charge/discharge cycles until capacity fades to 50% of initial capacity.

“Loading level” shall mean the ratio of the mass of active material to the void space within a porous substrate filled with active mass (g/cm³ vv). The loading value is determined by the following expression.

$$\begin{matrix}Loading \\ level\end{matrix} = \frac{mass of active material ( grams )}{void volume ( vv ) within substrate ( cubic centimeters )}$$

“Monolithic substrate” shall mean a substrate cast as a single piece and having no joints or seams. A monolithic substrate is intrinsically machinable to any desired thickness or shape.

“Volumetric capacity” shall mean the discharge capacity per unit volume (Ah/cm³) of the electrode.

“Wetting agent” shall mean any inorganic or organic, water-soluble polar solvent having a high affinity for carbon foam materials. Wetting agents may be used to enhance deposition in the pores of carbon foam. Typical wetting agents may include alcohols (e.g., methanol, ethanol, propanol and butanol), glycols (e.g., ethylene glycol) and ketones (e.g., methyl ethyl ketone).

“Working electrode” shall mean the electrode where the reaction of interest is occurring. The working electrode may be either the anode or the cathode, but in the case of the nickel electrode it is the cathode.

### SUMMARY

In one embodiment, the invention provides an electrode comprising a porous monolithic carbonaceous substrate having an active mass deposited thereto.

In another embodiment the invention provides a method of making an electrode comprising producing a coated substrate by depositing an active mass onto a porous monolithic carbonaceous substrate, wherein the active mass comprises at least one of nickel hydroxide, nickel oxyhydroxide, and a combination thereof, and activating (or forming) the active mass by cyclically charging and discharging the coated substrate in an electrolytic solution.

In yet another embodiment, the invention provides a battery comprising a cathode having a porous monolithic carbonaceous substrate attached to a current collector and coated with an active mass, a second electrode comprising a metal, and an electrolyte.

Other aspects of the invention will become apparent by consideration of the detailed description and accompanying drawings.

### BRIEF DESCRIPTION OF THE DRAWINGS

FIG. 1 shows the a) charge and b) discharge cycles (1 to 8) of active mass deposited onto MB foam.

FIG. 2 shows the a) charge and b) discharge capacities of cycles 5 to 10 for an MB foam electrode deposited using a 2.0 M nickel nitrate solution in water at 25° C. (20% KOH).

FIG. 3 shows the a) charge and b) discharge capacities of an MB foam electrode deposited using a 2.0 M nickel nitrate solution in water at 80° C. (20% KOH).

FIG. 4 is a comparison of a) volumetric and b) gravimetric capacities obtained for carbon foam samples deposited using 2.0 M nickel nitrate solution at 80° C. (20% KOH).

FIG. 5 shows the a) charge and b) discharge cycles of an MB foam electrode electrochemically deposited using 2.0 M nickel nitrate in a 45% ethanol solution (20% KOH).

FIG. 6 is a comparison of a) volumetric and b) gravimetric capacities obtained from carbon foam samples deposited using 2.0 M nickel nitrate in a 45% ethanol solution.

FIG. 7 shows the a) charge and b) discharge cycles of an MB foam electrode electrochemically deposited using 2.0 M nickel nitrate in a 45% methanol solution (20% KOH).

FIG. 8 is a comparison of a) volumetric and b) gravimetric capacities obtain for carbon foam samples deposited using 2.0 M nickel nitrate in a 45% methanol solution.

FIG. 9 is the charge/discharge capacities for carbon foam electrodes that have been a) chemically and b) thermally deposited with active mass.

FIG. 10 is a comparison of electrode swelling based on different nickel nitrate solution used for electrochemical deposition.

FIG. 11 is a comparison of average active mass loading levels achieved using four different solvent with the electrochemical deposition method. (average for 3 electrodes)

FIG. 12 shows the IR spectra of electrochemically deposited Ni(OH)₂ at a) high currents and b) low currents.

FIG. 13 shows the IR spectra regression at a) high deposition current and b) low deposition current.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The present invention provides a novel nickel-carbon electrode, and methods for making the same. The nickel-carbon electrode comprises an active mass (e.g., a nickel oxyhydroxide, nickel hydroxide or nickel oxide) deposited to a carbon foam using any one of chemical deposition, thermal deposition or electrochemical deposition. The nickel-carbon electrode is comparable in volumetric capacities (mAh/cc) with commercial electrodes but higher in gravimetric capacities (mAh/g). In some embodiments, a nickel battery life in excess of 300 charge/discharge cycles may be achievable with the nickel-carbon electrode.

The Carbon Foam

The nickel-carbon electrode may comprise carbon foam, namely, a porous monolithic carbonaceous substrate having an open microcellular structure. The porous carbon foam offers significant potential as a low-cost, high-performance electrode material to replace sintered nickel plaque in weight-critical uses.

Graphitization, using heat treatment, may optionally be used to order the graphite layers within the foam and enhance the current-carrying capacity of the foam. The temperature range for heat treatment is based upon the material property desired.

By adjusting the variables in the manufacturing process, carbon foams can be produced according to a variety of pore sizes, densities and crystallinity. With regards to the latter, the carbon foam may be amorphous, crystalline or a combination thereof. Suitable carbon foams may be commercially obtained from Poco Graphite, Inc. in Decatur, Tex.

The carbon foam serves as a mechanical support and a current collector for the nickel-carbon electrode. The carbon foam may be machined into virtually any desired shape and size and may optionally be attached to a second current collector (e.g., nickel foil) with a conducting carbon paste, such as RESBOND™ 931P Graphite Putty available from Cotronics Corp. in Brooklyn, N.Y. In one specific embodiment, the carbon foam is cut to a thickness of about 0.07 cm using a diamond blade. This further includes embodiments where the carbon foam is cut into the dimensions of about 1 cm by about 1 cm by about 0.07 cm.

The carbon foam may exhibit at least one property that makes it ideally suited as the mechanical support for the active mass making up the nickel-carbon electrode. For example, the carbon foam may possess at least one of relatively high conductivity as a current collector (i.e., an electrical resistivity below about 10,000 ohm-cm), good mechanical strength, machinability, resistance to chemical reactivity, and a combination thereof. The carbon foam may also exhibit good ion mass transfer facilitated by relatively large pores sizes. This includes embodiments in which the pore sizes range from about 1 to about 3,000 microns and further includes embodiments where the pore sizes range from about 1 to about 1,000 microns. The carbon foam may also exhibit a high loading level for the active mass that compares favorably with the loading level of 1.8 to 2.1 g/cm³ for commercial nickel plaques.

The Active Mass

The nickel-carbon electrode is made by depositing an active mass onto a carbonaceous substrate, which may comprise a carbon foam that has been cut to the desired dimensions. The active mass is the electroactive component of the nickel-carbon electrode. The reaction chemistry of the active mass participates in the charging and discharging of a nickel-based battery. The active mass typically comprises a crystal lattice of nickel hydroxide, nickel oxyhydroxide, nickel oxide or a combination thereof.

The following reaction is an oversimplified representation of the discharge (as written) and the charge reactions occurring in the nickel-carbon electrode:
NiOOH+H⁺+e⁻ [symbol] Ni(OH)₂ (1)
The nickel ions are reduced or oxidized within the crystal lattice. During the discharge step, protons migrate from the electrolyte into the crystal lattice. This is accompanied by reduction of the Ni³⁺ or Ni⁴⁺ ions. On charging, the H⁺ ions move from the crystal lattice toward the counter electrode. This is accompanied by oxidation of the Ni²⁺ ions. Thus charge/discharge results in the formation of an oxidized/reduced crystallographic phase.

The reaction in Equation 1 represents the “idealized state” of nickel hydroxide oxidation and reduction. In real electrode reactions, the active mass has a disordered crystalline structure and non-stoichiometric composition. The electrode reactions form nickel compounds with a variable, average nickel oxidation state between 2+and 4+, depending upon the state of charge and electrode potential. The actual active mass is a mixture of the three possible oxidation states (Ni²⁺, Ni³⁺ or Ni⁴⁺).

In 1966, Bode and coworkers (H. Bode, K. Dehmelt and J. Witte, Electrochim Acta, 11, p. 1079 (1966)) identified four phases of active mass and described the electrode reaction in terms of these phases. The phases are related schematically as shown below. 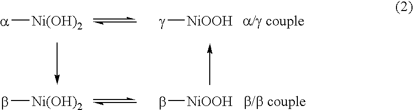
Oxidation or charging of α-Ni(OH)₂ gives γ-NiOOH, and oxidation or charging of β-Ni(OH)₂ gives β-NiOOH. On overcharge, the β-phase transforms to the γ-phase, and the active mass reactions go to the α-γ cycle. In concentrated alkali (e.g., KOH) solution, the α-phase ages to the β-phase and the reaction goes to the β-β cycle.

In 1980, Barnard, et al. determined the empirical formula for the four types of active material, and designated ‘activated’ and ‘deactivated’ forms of each of the discharged materials, β-Ni(OH)₂ and α-Ni(OH)₂. The empirical formulae for the four active phases observed by Barnard, et al. are listed in Table 1.

TABLE 1
Comparison of Empirical Formulae Calculated By Barnard, et al.¹ and the
Point Defect Based Formulae Calculated by Cornilsen, et al.²

| Nickel Oxidation State | Empirical Formula | Point Defect Formula |
|---|---|---|
| 2.25 (2 Beta) | 0.25NiOOH.0.75Ni(OH)₂.0.25H₂O | Ni_{0.89}V_{Ni0.11}OOH_{2.0} |
| 2.90 (3 Beta) | 0.90NiOOH.0.10Ni(OH)₂.0.21H₂O.0.033KOH | Ni_{0.89}(3H)_{Ni0.08}K_{Ni0.03}OOH_{1.20} |
| 2.25 (2 Alpha) | 0.125NiO₂.0.875Ni(OH)₂.0.67H₂O | Ni_{0.75}(H)_{Ni0.25}OOH_{2.10} |
| 3.67 (3 Gamma) | K_{0.33}NiO₂.0.67H₂O | Ni_{0.75}(K)_{Ni0.25}OOH_{1.00} |

¹R. Barnard, G. T. Crickmore, and J. A. Lee, J. App. Electrochem., 10, 127-141 (1980).
²P. L. Loyselle, P. J. Karjala, and B. C. Cornilsen, “A point Defect Model For Nickel Electrode Structures.” Electrochemical and Thermal Modeling of Battery, Fuel Cell and Photoenergy Conversion Systems, 86-12 (J. R. Selam and H. C. Maru, Eds.), The Electrochemical Society, 1986, pp. 114-121.

Cornilsen and coworkers modified the reaction schematic of equation 2 based on additional structural detail extracted from Raman spectral results together with the empirical formulae of Barnard, et al., as shown below. 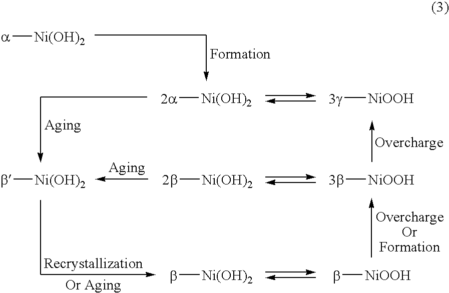
Cornilsen, et al. noted that the empirical formulae for Ni(OH)₂ and NiOOH do not maintain the Ni:O:H ratio of 1:2:2 and 1:2:1, respectively, and they proposed a structural model containing point defects to explain the results. According to this model, the point defect formulae (normalized to two moles of oxygen), Ni₁₋ₓVₓOOH₂ or Ni₁₋ₓVₓOOH, represent the nonstoichiometric structures for Ni(OH)₂ or NiOOH, respectively. The vacant lattice sites, V, may remain vacant or be occupied by ions such as cobalt, potassium and hydrogen. The point defect formulae are compared with the empirical formulae of Barnard, et al. for different oxidation states in Table 1.

Deposition of Active Mass onto Carbon Foam

The nickel-carbon electrode comprises an active mass (e.g., a nickel oxyhydroxide, nickel hydroxide or nickel oxide) deposited to a carbon foam using any one of chemical deposition, thermal deposition or electrochemical deposition. Deposition of the active mass by electrochemical or chemical methods can be done from a nickel(II) salt solution, such as a solution of Ni(NO₃)₂. The solution may comprise water or a combination of water and one or more wetting agents. The wetting agents enhance the deposition process by wetting the carbon foam and making it possible to effectively deposit the active mass into the porous carbon foam. Thermal deposition of Ni(OH)₂ can also be done by immersion of the carbon foam in a molten Ni(NO₃)₂.6H₂O. Deposition, as used in the present invention, may include the deposition of active mass within the pores of the carbon foam and/or deposition of active mass on the external surface of the carbon foam. For all deposition methods, a number of subsequent charge/discharge cycles forms, or activates, the active mass. The deposition and formation steps do not alter the properties and structure of the carbon foam support. Each of these steps is disclosed in more detail below.

Chemical deposition may comprise dipping the carbon foam into a nickel(II) salt solution (e.g., Ni(NO₃)₂) followed by an alkaline solution (e.g., KOH solution) and repeating the dipping process until deposits begin to appear on the surface of the carbon foam. The nickel(II) salt solution may be an aqueous solution. More preferably, a wetting agent is added to the aqueous nickel(II) salt solution to enhance the deposition process. Suitable wetting agents may include alcohols (e.g., methanol, ethanol, propanol and butanol), glycols (e.g., ethylene glycol) and ketones (e.g., methyl ethyl ketone). The nickel(II) salt solution typically comprises greater than about 1% by volume, more particularly greater than about 35% by volume, and even more particularly greater than about 50% by volume wetting agent. The aqueous Ni(II) salt solution typically comprises less than about 60% by volume, more particularly less than about 40% by volume, and even more particularly less than about 20% by volume wetting agent. In one embodiment, the nickel(II) salt solution comprises about 35% to about 55% by volume wetting agent. The temperature of the nickel(II) salt solution, with or without a wetting agent, may be maintained at room temperature or at some elevated temperature. In some embodiments, the temperature of the nickel(II) salt solution is maintained at about 20 to about 80° C. The alkaline solution typically comprises greater than about 10% by weight OH⁻, more particularly greater than about 20% by weight OH⁻, and even more particularly greater than about 35% by weight OH⁻. The alkaline solution typically comprises less than about 45% by weight OH⁻, more particularly less than about 35% by weight OH⁻, and even more particularly less than about 25% by weight OH⁻. In one embodiment, the alkaline solution comprises about 10 to about 45% by weight KOH.

In one embodiment, an aqueous solution of about 1 to about 2 M Ni(NO₃)₂ is heated to about 60° C. The carbon foam is immersed in the solution for about 20 minutes for the first loading cycle and 15 minutes for subsequent cycles. The carbon foam is then immersed in an aqueous solution of about 2 M KOH for about 20 minutes. This process is repeated until deposits appear on the carbon foam surface. The resultant nickel-carbon electrode is then rinsed with distilled, de-ionized water.

In an alternative embodiment, a 50% by volume methanol-water solution of about 1 to about 2 M Ni(NO₃)₂ is heated to about 45° C. The carbon foam is immersed in the solution for about 20 minutes for the first loading cycle and about 15 minutes for subsequent cycles. The carbon foam is then immersed in an aqueous solution of about 2 M KOH for about 20 minutes. This process is repeated until deposits appear on the carbon foam surface. The resultant nickel-carbon electrode is then rinsed with distilled, de-ionized water.

Thermal deposition comprises dipping carbon foam in molten Ni(NO₃)₂.6H₂O to form deposits which may then be converted to Ni(OH)₂ active mass using an aqueous alkaline solution. The aqueous alkaline solution typically comprises greater than about 10% by weight OH⁻, more particularly greater than about 20% by weight OH⁻, and even more particularly greater than about 35% by weight OH⁻. The alkaline solution typically comprises less than about 45% by weight OH⁻, more particularly less than about 35% by weight OH⁻, and even more particularly less than about 25% by weight OH⁻. In one embodiment, the alkaline solution comprises about 10 to about 45% by weight KOH.

In one embodiment, the carbon foam is pre-heated to about 200° C. for about 10 minutes and immersed in molten Ni(NO₃)₂.6H₂O. The deposited carbon foam is removed from the molten salt and again heated to about 200° C. for about 30 minutes to change the salt to Ni(OH)NO₃. These two steps are repeated until green deposits appear on the carbon foam surface. The deposited carbon foam is then placed into a 25 wt % KOH solution for about 16 hours to convert Ni(OH)NO₃ to Ni(OH)₂ active mass. The resultant nickel-carbon electrode is then rinsed with distilled de-ionized water.

Electrochemical deposition is carried out in an electrochemical cell containing a nickel(II) salt solution. The nickel(II) salt solution typically comprises about 1 to about 2 M Ni(II). The carbon foam onto which the active mass is deposited serves as the cathode and nickel foil (e.g., 3 cm×3 cm) serves as the anode. The current applied for each deposition is based on the target current density times the projected area of one side of the electrode (however, both sides are open for deposition). The temperature is maintained using a constant-temperature bath. Acid (e.g., nitric acid) may be added to the nickel(II) salt solution to keep the pH in the range of about 2.5 to about 3.5. The pH of the solution is monitored periodically during the deposition and adjusted accordingly. The resultant nickel-carbon electrode is then washed.

In one embodiment, the nickel(II) salt solution comprises an aqueous solution of about 1 to about 2 M Ni(NO₃)₂ and about 0.3 M NaNO₂. The cell is operated at a temperature of about room temperature to about 90° C., at a constant current density of about 15-76 mA/cm², and for a duration of about 30-180 minutes.

In an alternative embodiment, the nickel(II) salt solution comprises an aqueous solution of about 1 to about 2 M Ni(NO₃)₂ and a wetting agent. Suitable wetting agents may include alcohols (e.g., methanol, ethanol, propanol and butanol), glycols (e.g., ethylene glycol) and ketones (e.g., methyl ethyl ketone). The Ni(II) salt solution typically comprises greater than about 1% by volume, more particularly greater than about 40% by volume, and even more particularly greater than about 50% by volume wetting agent. The aqueous Ni(II) salt solution typically comprises less than about 60% by volume, more particularly less than about 40% by volume, and even more particularly less than about 20% by volume wetting agent. In one embodiment, the aqueous Ni(II) salt solution comprises about 35% to about 55% by weight wetting agent. The cell is operated at a temperature of about 40-70° C., at a constant current density of about 55-80 mA/cm², and for a duration of about 150-240 minutes.

The primary deposition variable that affects the capacity of an electrode is the loading of the active mass onto the carbon foam substrate. The higher the level of loading, the greater the potential charge capacity of the electrode. The loading of active mass within the porous carbon foam varies with the nature of the carbon foam and the deposition method. Generally, however, the loading of active mass onto a carbon foam substrate is greater than about 0.5 g/cm³ vv, more particularly greater than about 1.0 g/cm³ vv and even more particularly greater than about 1.8 g/cm³ vv. The loading of active mass onto a carbon foam substrate is typically less than about 1.2 g/cm³vv, more particularly less than about 1.5 g/cm³ vv and even more particularly less than about 2.0 g/cm³ vv.

Additives

Transition metals and lanthanide group metals may be added to the active mass to further enhance the electrochemical properties of the nickel-carbon electrode. Ionic and electronic conductivity are improved by controlling lattice imperfections in the active mass. For example, the resistance to proton diffusion in the charged electrode is lowered. Additives also improve the charge efficiency of the electrode and the utilization of the active material, and stabilize the capacity during cycling. Active mass utilization is increased because O₂ evolution is constrained during the charging by increasing the oxygen overvoltage, making the electrode easier to charge as the charging voltage is reduced. Electrode capacity is increased by promoting reversibility of the Ni(II)/Ni(III) redox reaction. Mechanically, additives restrain grain growth during cycling, which improves the elastic properties of the active material and reduces electrode swelling. These factors may contribute to improved capacity and extended electrode cycle life.

Suitable additives may include, but are not limited to, ions of lithium, potassium, iron, zinc, cobalt, manganese, aluminum, zirconium, yttrium, lanthanide group metals, and a combination thereof. Additives may be present in a concentration of about 0.1 to about 35 mole percent. More particularly, additives may be present in a concentration of about 1 to about 25 mole percent of cation sites. A typical composition of the active mass comprising an additive includes Ni_{(1-w-x-y)}M_{w}(nH)ₓK_{y}OOH_{(2-z)}, where (x+y)≦0.25, x≦0.25, y≦0.25, n≦4, w≦0.5, z≦2, M=a transition metal or a lanthanide group metal, and waters of hydration may or may not be present.

Formation of the Active Mass

After deposition by one of the methods disclosed above, the nickel-carbon electrode is formed, or activated, through a series of charge and discharge cycles. The formation may be done in an electrochemical cell at room temperature using an alkaline solution (e.g., about 20 wt % KOH) as the electrolyte. The nickel-carbon electrode is the cathode during discharging and the anode during charging. The current density for the forming cycles is typically greater than about 15 mA/cm², more particularly greater than about 45 mA/cm², and even more particularly greater than about 90 mA/cm². The current density for the forming cycles is typically less than about 120 mA/cm², more particularly less than about 80 mA/cm², and even more particularly less than about 40 mA/cm². During each cycle, the electrode is charged for about 20 minutes and discharged until the voltage drops to a cut-off potential of about 1 to about 0 V relative to a reference saturated calomel electrode (SCE). Formation of the nickel-carbon electrode may take from about 5 to about 200 charge/discharge cycles. In one embodiment, a current density of about 60 mA/cm² is used for about the first eight cycles and a current density of about 15 mA/cm² is used for subsequent cycles. During each cycle, the electrode is charged for about 20 minutes and discharged until the voltage drops to a cut-off potential of about −0.5 V relative to a reference saturated calomel electrode (SCE).

The formed nickel-carbon electrode may be further cycled at room temperature for about 10-15 cycles to observe the maximum capacity attained by the electrode and its initial behavior during repeated charging and discharging. An electrolyte comprising about 20 wt % KOH may be used. Currents ranging from about 10 to about 32 mA/cm² (based on the surface area of one side of the electrode) can be used for charging. Charging times about 20 to about 40% higher than discharging times are used to ensure complete charging.

Discharging is done with currents ranging from about 10 to about 25 mA/cm² (based on the surface area of one side of the electrode). The electrode is discharged until the voltage drops to the cut-off potential of about −0.5 V (vs. SCE reference electrode). After repeat cycling, the electrode is washed with water and dried in a dessicator. The nickel-carbon electrode is typically black in color after the formation and cycling steps.

### EXAMPLES

Exemplary embodiments of the carbon foam and nickel-carbon electrodes made therefrom are provided in the following examples. The following examples are presented to illustrate the nickel-carbon electrode and its various components and to assist one of ordinary skill in making and using the same. The examples are not intended in any way to otherwise limit the scope of the invention.

Instrumentation and Methods

Carbon Foam Samples

Carbon foam samples used to make the nickel-carbon electrodes were obtained from commercial vendors. The B and D series foams were produced from coal-based precursor materials and include samples B1 through B7 and D1 through D4. MB was a standard foam produced from Mitsubishi ARA24 synthetic resin. PocoFoam (Pf) and Poco-HTC samples were obtained from Poco Graphite, Inc. in Decatur, Tex.

The thickness of the foam samples used for experimentation was as per the dimension of the commercially available sintered nickel plaque. The carbon foam was cut using diamond blades to a thickness of 0.07 cm. The carbon foam electrode areas of 1 cm by 1 cm were typically used; however, a few electrodes had slightly different dimensions. The foam was pasted to a wire current connector with RESBOND™ 931P, Graphite Putty from Cotronics Corp. in Brooklyn, N.Y.

Electrochemical Cell

The electrochemical cell comprised a 60 ml sample jar having three compartments. A working electrode was placed in the center compartment, and one counter electrode was placed in each of the remaining compartments. The counter electrode was a 3 cm by 3 cm nickel foil. The reference electrode was a saturated calomel electrode (SCE) placed 2 cm from the working electrode.

Particle Porosity

The particle porosity (εₚ) of different carbon foam samples was calculated from the particle density (Qₚ) and material density (Q_{M}) using the following relationship:

$${ε}_{p} = \frac{{Q}_{M} - {Q}_{p}}{{Q}_{M}} = 1 - \frac{{Q}_{p}}{{Q}_{M}}$$

To evaluate Qₚ and Q_{M}, a sample of carbon foam was weighed (m₁) and then its pores were filled with benzene (of density p). After complete wetting, the outer surface of the sample was dried using a paper towel. A 10 ml pycnometer was weighed when empty (m₂) and then the sample was put in it and weighed again (m₃). The pycnometer was filled with benzene and again weighed (m₄). The Qₚ and Q_{M} values were calculated according to the following:

$${Q}_{p} = \frac{{m}_{1}}{10 - \frac{( {m}_{4} - {m}_{3} )}{ρ}}$$

$${Q}_{M} = \frac{{m}_{1}}{\frac{{m}_{1}}{{Q}_{p}} - \frac{( {m}_{3} - {m}_{2} - {m}_{1} )}{ρ}}$$

Cyclic Voltammograms

A Parstat model 2263 Pontentiostat/Galvanostat was used for the electrochemical testing. The Parstat operates with the Electrochemistry PowerSuite@ software and has minimum current resolution of 120 fA. It uses four 16 bit analog-to-digital converters (ADCs) to measure current and potential and a microprocessor to perform the experiment defined by the PowerSuite@ software.

Deposition of Active Mass

Three different methods were used to deposit active mass onto the carbon foam. All depositions were done in a fume hood. Personal protection included use of goggles, gloves and lab coat.

Two different methods were used for chemical deposition.
1) Initially, a 2.0 M Ni(NO₃)₂ aqueous solution was prepared and heated to 60° C. in a vacuum furnace.
2) Later, a 2.0 M Ni(NO₃)₂ in a 50% by volume methanol solution was prepared and heated to 45° C. in a vacuum furnace.
   The foam electrodes were dipped in these solutions for 20 minutes for the first loading cycle and 15 minutes for subsequent cycles. These electrodes were then dipped in 2.0 M aqueous KOH solution for 20 minutes. The above steps were repeated for 4-5 cycles until deposits started appearing on the surface of the electrode. Finally, the electrodes were washed with distilled, de-ionized water, and formed.

In the thermal deposition method, nickel nitrate salt {Ni(NO₃)₂.6H₂O} was heated (using a hot plate) to the temperature where it started to melt. The carbon foam pieces, which were heated to 200° C. for 10 minutes in the furnace, were dipped in the molten salt. The deposited carbon foam pieces were again heated to 200° C. for 30 minutes to change the salt to Ni(OH)NO₃. These two steps were repeated for 3-4 cycles until green deposits started showing on the electrode surface. The deposited carbon foam pieces were then placed in a 25% by weight KOH solution for 16 hours to convert Ni(OH)NO₃ to Ni(OH)₂ active mass. The nickel-carbon electrodes were rinsed with distilled de-ionized water and formed.

Electrochemical deposition was carried out in an electrochemical cell. Carbon foam pasted to a nickel foil current collector served as the cathode and nickel foil served as the anode. All depositions were done at constant current. Table 2 lists the different conditions used for the electrochemical depositions. The current applied for each deposition was based on the current density used times the projected area of one side of the electrode (however, both sides were open for deposition). The temperature was maintained using a constant temperature bath of 50% by volume ethylene glycol solution. Drops of nitric acid were added to the nickel nitrate solution to keep the pH in the range of 2.5-3.5. The pH of the solution was monitored intermittently during the deposition and adjusted accordingly. The electrodes were then washed and formed.

TABLE 2
Electrochemical Conditions for Active Mass Depositions.

| | | Current Density | Time |
|---|---|---|---|
| Solution | Temperature (° C.) | (mA/cm²) | (minutes) |
| 2.0 M Ni(NO₃)₂ | Room Temperature | 77.5 | 120 |
| 0.3 M NaNO₂ | | | |
| 2.0 M Ni(NO₃)₂ | 80 | 77.5 | 120 |
| 0.3 M NaNO₂ | | | |
| 2.0 M Ni(NO₃)₂ | 90 | i) 15 | i) 30-45 |
| 0.3 M NaNO₂ | | ii) 30 | ii) 60-80 |
| | | iii) 55 | iii) 120-180 |
| 1.8Ni(NO₃)₂ | 70 | 55 | 150-240 |
| in 45% ethanol | | | |
| 1.8Ni(NO₃)₂ | 50 | 80 | 150-240 |
| in 45% methanol | | | |

Formation and Charge/Discharge Cycling

The formation of the nickel electrode was done through a series of charge/discharge cycles to activate the deposited material and achieve consistent electrochemical behavior. The formation was done in the cell using 20% by weight KOH as the electrolyte. The nickel-carbon electrode was the cathode during discharge and the anode during charge.

For each cycle, the electrode was charged for 20 minutes and discharged until the voltage dropped to the cut-off potential of −0.5V (relative to the SCE electrode). The formed electrodes were further cycled for 10-15 cycles to observe the maximum capacity attained by the electrode and the behavior of the electrode during repeated charge and discharge cycle. The parameters for constant current charge and discharge are provided in Table 3. The electrolyte used was a 20% by weight KOH solution.

TABLE 3
Cycling Conditions for Nickel-Carbon Electrode Formation

| Cycles | Current Density (mA/cm²) |
|---|---|
| 1-8 | 60 |
| 9-10 | 15 |

Charging was done at a 20 mA/cm² charge rate (based on the area of one side of the electrode surface). For some electrodes, charge currents of 10, 25 or 32 mA/cm² were used. Charging times were required to be 20-40% higher than discharging times to assure complete charging.

Discharging was done at 20 mA/cm² discharge rate (based on the area of one side of the electrode). For some electrodes, discharge currents of 10, 16 or 25 mA/cm² were used. The electrode was discharge until the voltage dropped to the cut off potential of −0.5 V.

After cycling, the electrodes were washed with water and dried in a dessicator. The electrodes were black in color after formation and cycling steps. Both formation and cycling were carried out at room temperature.

Infrared Spectra

IR spectra of electrochemically deposited Ni(OH)₂ was obtained. Sample KBr pellets were prepared by vacuum pressing a mixture of 0.4 mg of sample and 230 mg of KBr. The samples were scanned using a Thermo Mattson FTIR spectrometer. Spectra were collected in the mid-IR region (4000-400 cm⁻¹) at 4 cm⁻¹ resolution with 128 scans.

Physical Analysis

The physical structure of different carbon foam samples before and after deposition was studied using scanning electron microscopy (SEM). For SEM, a resolution of 200 μm (corresponding to 100× magnification) was used.

Electrical Resistivity Measurements

Electrical resistivity measurements were done using the in-plane electrical resistivity test method. A Keithley 182 Digital Sensitive Voltmeter and a Keithley 224 Programmable Current Source were used. Samples were prepared by cutting them into sticks of dimensions about 1.8 mm wide (w) by about 1.8 mm thick (t) and about 25.4 mm long. The resistivity (E_{R}) was measured by applying a constant current (I=20 to 100 mA) and measuring the potential drop (ΔV) over the center 5.8 mm (L) of the sample length. The electrical resistivity was obtained from the following equation.

$${E}_{R} = \frac{Δ V \cdot w \cdot t}{I \cdot L} \qquad ( 4 )$$

### Example 1

Electrical Resistivity

Resistivity values for the various carbon foams is provided in Table 4. The resistance for the B series samples decreased as the graphitization temperature increased and reached a minimum for the B4 sample. The resistance increased as the graphitization temperature was further increased. For the D series samples, the resistance values became lower as the graphitization temperature was raised. Overall, the MB and Pf samples exhibited lower electrical resistances compared to the B and D series samples.

TABLE 4
Electrical Resistivity Measurements

| Sample | Resistivity (ohm-cm) |
|---|---|
| Nickel plaque | 0.0004 |
| Mitsubishi | 0.0032 |
| Pf¹ | 0.0026 |
| D1 | 0.0311 |
| D2 | 0.0187 |
| D4 | 0.0216 |
| B1 | 0.0252 |
| B2 | 0.0236 |
| B4 | 0.0205 |
| B6 | 0.0221 |

¹“What is PocoFoam,” http://www.pocothermal.com/html/whatis.html (Sept. 20, 2002).

### Example 2

Sample Porosity

The results of porosity measurements for the foam samples are listed in Table 5. With the exception of the MB foam, the porosities are similar to that of the porosity of commercial nickel plaque. The MB foam exhibits a slightly lower porosity than the others. SEM results suggest that the pore sizes of the B and D series foams were considerably larger than that of commercial nickel plaque (Table 8). Available literature values are given in the table for commercial nickel plaque, MB foam and Pf foam.

TABLE 5
Pore Size Comparison of Different Carbon Foam Samples

| Samples | Pore Size (μm) | % Porosity (Ave.) |
|---|---|---|
| Nickel Plaque¹ | 50-70 | 70-85 |
| MB² | 90 | 55-60 (56) |
| Pf³ | 350 | 70-77 (75) |
| B Series⁴ | >1000 | 70-75 |
| D Series⁴ | >700 | 75-80 |

¹G. Halper, “The Nickel Hydroxide Electrode - An Overview,” Nickel Hydroxide Electrodes, Proc. Vol. 90-4 (D. A. Corrigan, A. H. Zimmerman; Eds.), The Electrochemical Soc. Inc., 1990, pp. 3-8.
²J. Klett, “High Thermal Conductivity, Mesophase Pitch-Derived Carbon Foam,” www.ms.ornl.gov/ott/publications/sampe98.pdf (Oct. 20, 2003).
³“What is PocoFoam,” http://www.pocothermal.com/html/whatis.html (Sept. 20, 2002)
⁴Michigan Technological University, 2001.

### Example 3

Formation of Active Mass

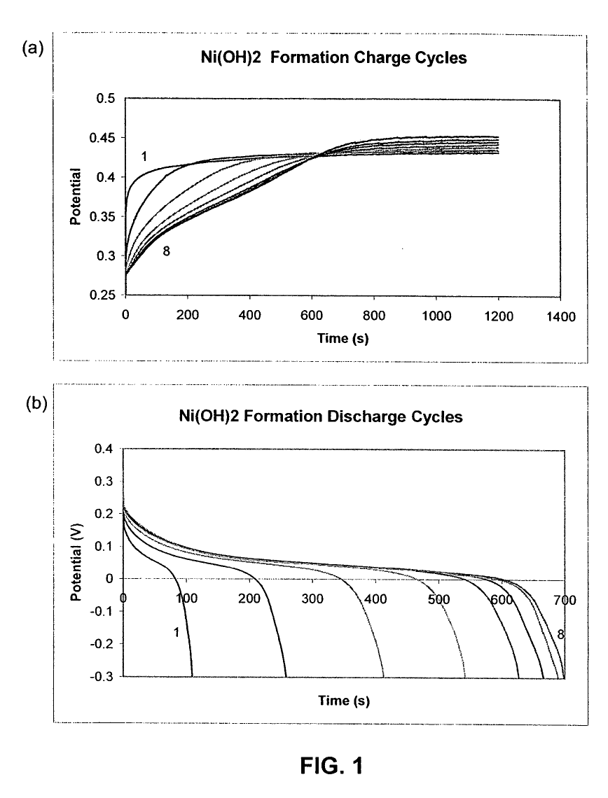

The charge and discharge cycles during the formation step of active mass are shown in FIG. 1. For most samples, the active mass was completely formed after eight cycles of forming. For those samples that had a higher level of loading and pore filling, the capacities obtained on discharge were comparatively low compared to the amount of charge, as eight cycles of formation did not charge them to their full capacity. The completely formed samples were black in color and had stable capacity. The samples that were not fully activated after formation had some green nickel hydroxide deposits visible in the pores. These samples were then fully activated during the constant capacity cycling tests.

### Example 4

Capacity cycling was the most crucial step in determining the feasibility of the foam sample as a potential electrode material. Electrodes with different foams and using different active mass deposition methods and conditions were cycled to determine the capacities for each. The optimum contribution of foam and deposition conditions was sought.

Sample 1

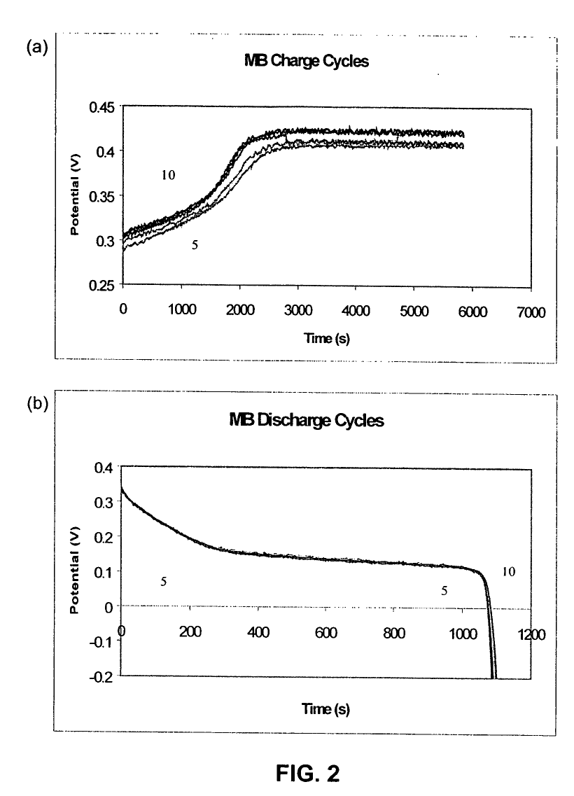

FIG. 2 presents the charge/discharge capacity for the MB foam sample electrode electrochemically deposited using the aqueous 2.0 M nickel nitrate solution at room temperature. The last five cycles of ten are shown. The last five capacities (10 mAh) were consistent with but approximately 26% lower than that for the first cycle. These low discharge capacities were lower than expected (25 mAh) compared to charging. Poor loading level of active mass at room temperature was the likely cause.

Sample 2

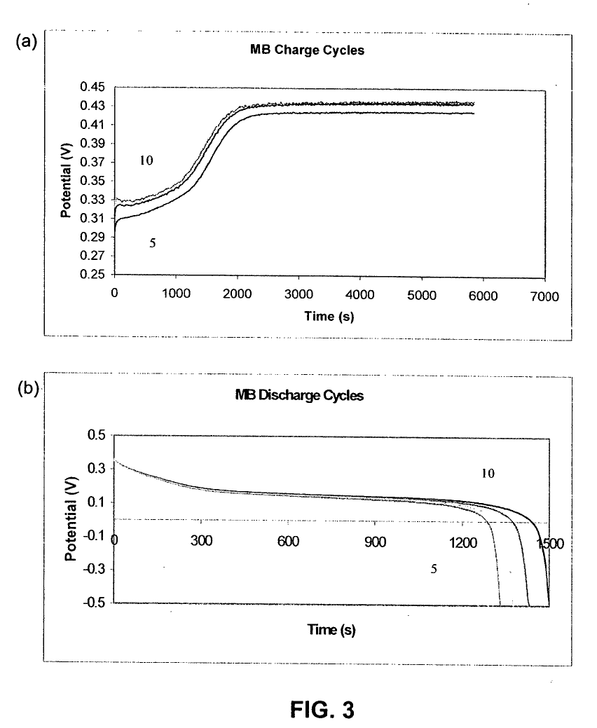

FIG. 3 shows the charge/discharge capacity for the MB foam electrode electrochemically deposited using the 2.0 M nickel nitrate solution at 80° C. The discharge capacities dropped from 15 mAh to 12 mAh over cycles 5 through 10. This drop is due to the loss of active material from the foam material during cycling (material is visible at the bottom of the cell).

Sample 3

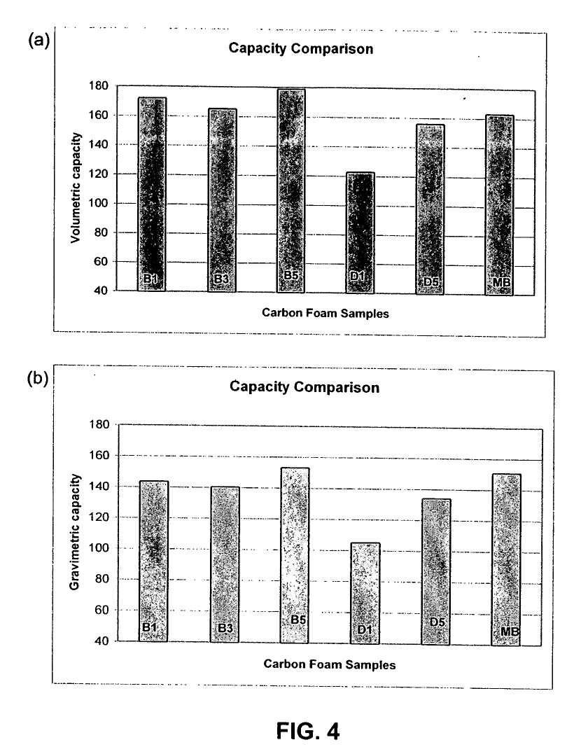

The volumetric and gravimetric capacities were used as a figure of merit to compare the cycling behavior for six different nickel-carbon electrodes produced by electrochemically depositing active mass onto carbon foam using a 2.0 M nickel nitrate solution at 80° C. These values were calculated by averaging the capacities of the last five cycles. The volumetric and the gravimetric discharge capacities for these six foam samples are compared in FIG. 4. The highest volumetric capacity achieved is about 178 mAh/cc and the gravimetric capacity is 153 mAh/g of electrode material (B5 sample). These values are lower than those of commercial nickel electrode capacities (550-600 mAh/cc and 150-200 mAh/g).

Sample 4

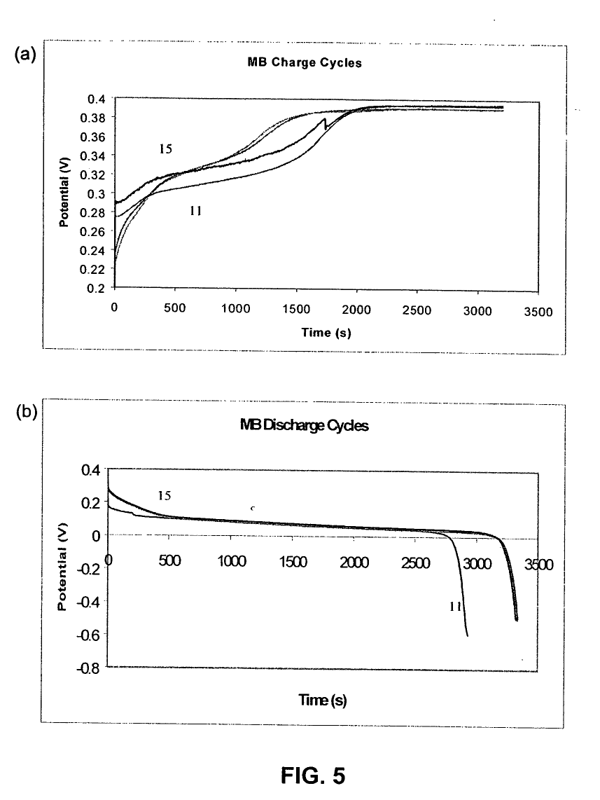

FIG. 5 shows the charge/discharge capacity for the MB foam electrode electrochemically deposited using 2.0 nickel nitrate in a 45% ethanol solution. As evident from the graph, these last five discharge capacities are stable and constant.

Sample 5

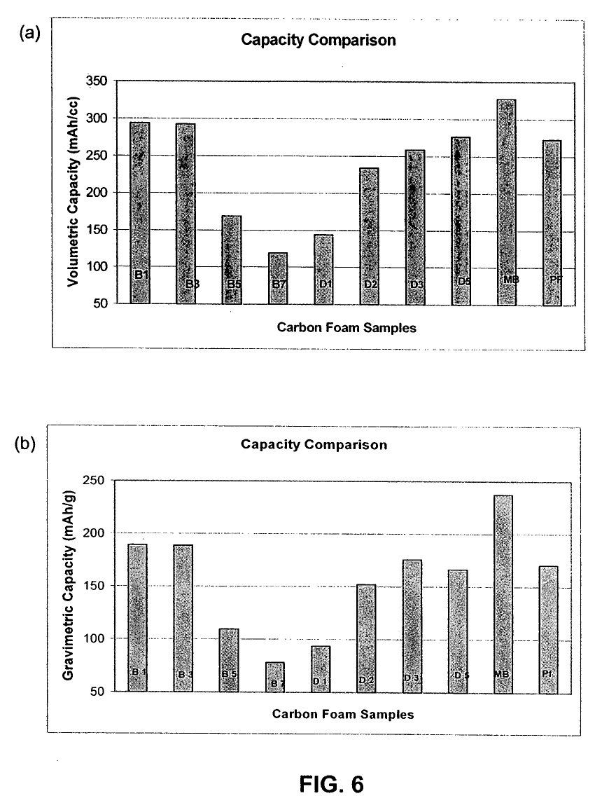

The volumetric and gravimetric capacities, as shown in FIG. 6, were determined for ten different nickel-carbon electrodes produced by electrochemically depositing active mass onto carbon foam using 2.0 M nickel nitrate in a 45% ethanol solution. These capacities for electrodes deposited using 45% ethanol solution were higher compared to the aqueous solution capacities discussed above. The volumetric capacity of about 327 mAh/cc for the MB electrode corresponds to a medium range capacity typical for a loading level of 1.4 g/cc of void volume. The loadings have been calculated from the discharge capacities assuming one mole of active mass gives one more of electrons. The gravimetric capacity is nearly comparable with that of a commercial nickel plaque capacity.

Sample 6

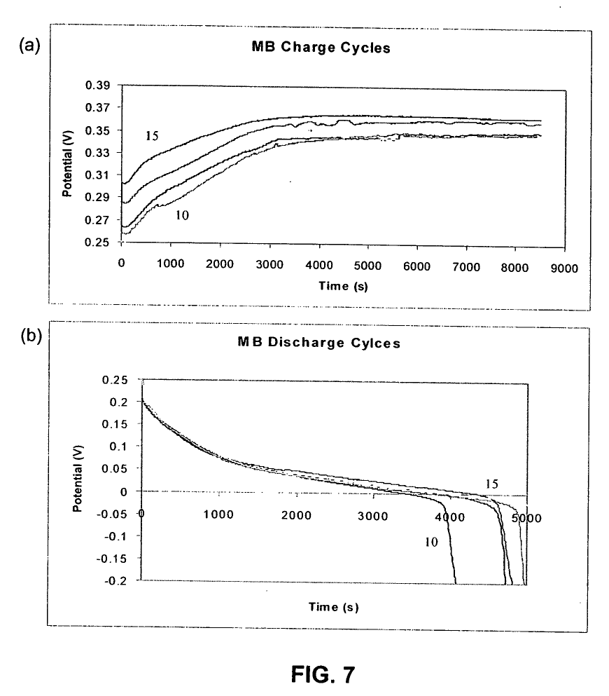

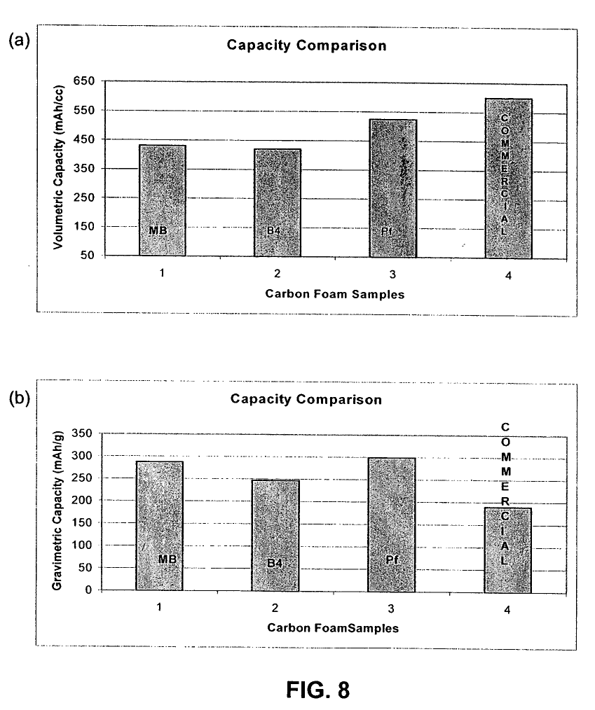

The Mitsubishi, PocoFoam and the B4 samples were electrochemically deposited using a 2.0 M nickel nitrate solution in 45% methanol. The plots for the last five charge and discharge cycles of MB foam electrode are shown in FIG. 7. The gravimetric and the volumetric capacities of the foam samples are shown in FIG. 8. The volumetric capacities of these samples are almost comparable to commercial electrodes and the gravimetric capacities are higher. The PocoFoam sample has the best capacity value among all the samples.

Sample 7

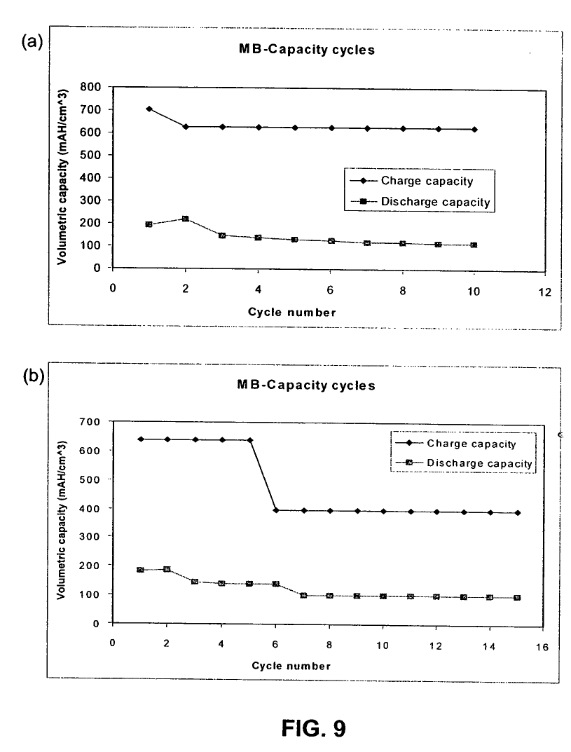

The charge and discharge capacities of the Mitsubishi samples deposited using chemical and thermal deposition methods are shown in FIG. 9. The volumetric capacity of 119 mAh/cm³ for the chemically deposited electrode and 100 mAh/cm³ for the thermally deposited electrode correspond to poor loading of 0.3-0.6 g/cm³ of the void volume. Since these deposition methods were poor, the other electrode materials were not studied using these deposition methods.

### Example 5

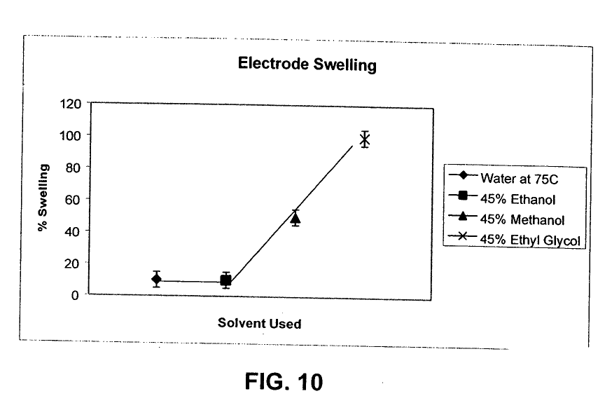

An important factor for consideration in nickel electrodes is the swelling of the active mass after deposition. Swelling during cycling is caused by the increase in the volume of active mass due to the diffusion of protons, water molecules, OH⁻ and K⁺ ions from the solution into the layers of the active mass structure. A large number of charge and discharge cycles will increase the electrode swelling. This swelling behavior has been investigated for MB electrodes with deposition from different nickel nitrate deposition solvents by simply soaking (overnight) the deposited electrodes (unformed) in the nickel nitrate solution in which they were deposited. FIG. 10 plots the percent swelling for these electrode (compared to their initial thickness). These electrodes were deposited at 77.5 mA. The electrodes deposited using water and ethanol as solvents had much less swelling. Methanol and ethylene glycol depositions show increased swelling.

The electrodes using 45% methanol solvent were deposited with current densities of 120, 77.5 and 35 mA/cm². These showed 60%, 40% and 30% swelling, respectively. The time duration for deposition was inversely proportional to the current applied to give similar loading. It is observed that the electrodes deposited at a higher current density swelled more than the electrodes using the lower current density.

### Example 6

Electrode Efficiency

The amp-hour electrode efficiency for different deposition methods was determined and compared with the commercial nickel electrode efficiencies. Table 6 lists these values for foam electrodes deposited using different methods. The values are also compared to the nickel plaque electrode values. The discharge capacity was measured as current multiplied by time until the voltage dropped to 0 V.

TABLE 6
Electrode Efficiencies for Different Deposition Methods

| | Efficiency |
|---|---|
| Deposition Method | % (Avg.) |
| Chemical | 30 |
| Thermal | 40 |
| Electrochemical at Room Temperature | 25-30 (27) |
| Electrochemical at 80° C. | 35-45 (42) |
| Electrochemical using 45% Ethanol Solvent | 50-70 (59) |
| Electrochemical using 45% Methanol | 53-70 (62) |
| Solvent | |
| Commercial Nickel Plaque¹ | 65-80 |

¹D. Berndt, Maintenance-Free Batteries, A Handbook of Battery Technology, 2^{nd} Edition, John Wiley & Sons, Inc., NY, 1997.

The efficiencies were high for the electrochemical deposition method using organic wetting agents. This may be due in part to improved loading which results from better contact between the active mass and the carbon foam when a wetting agent is used.

### Example 7

Initially, active mass was deposited onto foam samples using the electrochemical methods. Based on these capacities, the three most promising foam samples were selected (Pf, MB and B4) and the other methods of deposition (thermal and chemical) were applied to only on these three foams (Pf, MB and B4). The primary deposition variable that affects capacity is the active mass loading within a foam or plaque.

Electrochemical Deposition

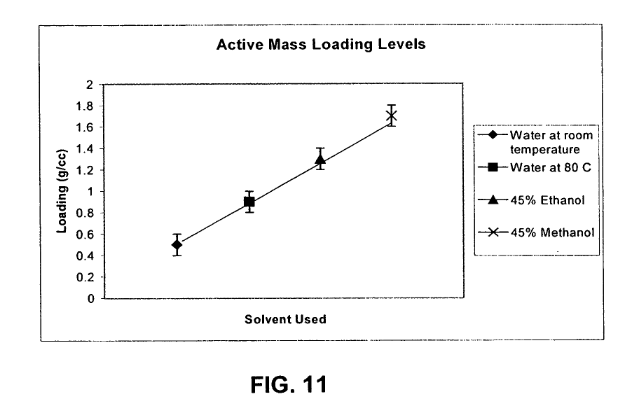

The first electrochemically deposited foams were produced in an aqueous nickel nitrate solution at room temperature. Electrochemically deposited foams were later produced by raising the temperature of deposition and changing the solvent (i.e., adding ethanol or methanol to the water). With aqueous Ni(NO₃)₂ at room temperature, much of the deposited material fell from the surface during the formation process, resulting in a low level of loading 0.3-0.5 g/cc of void volume. The data point in FIG. 11 is the average for the three samples MB, D1 and B4. The samples that were deposited using the same solution Ni(NO₃)₂ but at higher temperatures did show improvement in the loading and capacities. The deposition was more uniform and stable capacities were observed during cycling (see FIG. 3). However, most of the deposition still took place in the bigger pores, as seen from SEM examination, and loading values of 0.8-1.1 g/cm³ vv were still lower than the commercial electrode levels (1.8-2.1 g/cc vv).

Carbon foams are known to be hydrophobic, therefore, the above loading levels may result. The solution may not have wet the foam much beyond the surface and big pores. On the other hand, organic solvents have higher affinity for a foam material. Therefore, the ethanol was added to the aqueous nickel nitrate solution and used for deposition. The capacities obtained from the ethanol solutions were higher (see FIGS. 5-6), and it is believed that these result from improved loading; 1.2-1.5 g/cc vv (FIG. 3 again depicts the average for MB, Pf and B5). The success of aqueous ethanolic solutions suggested use of organic solvents that are deeply absorbed in the foam pores. A trial testing of other alcohol-based organic compounds was done. It was found that methanol is readily absorbed in the foam compared to four other solvents, which included propanol, butanol, ethylene glycol and methyl ethyl ketone (based on volume absorbed when standing for 1 hour in each solvent).

An aqueous methanol solution was then used for electrochemical deposition of the active material on the Mitsubishi, PocoFoam and B4 samples. All three samples showed loading values in the medium to high range (1.6-1.8 g/cc vv). Using the methanol solution further reduced the deposition temperature to 45° C. FIG. 11 compares the loading values for these four solvents. Methanol provided the best loading value. As is evident from the graph, the changes in temperature and solvent are critical in getting improved levels of loading and pore filling.

Chemical Deposition

Chemical deposition was done on the Mitsubishi and B4 foam samples. Loading of 0.6 g/cc of void volume was obtained. This loading was low, probably because an aqueous nickel nitrate solution was used. The hydrophobic nature of carbon foam again resulted in most deposits taking place on the surface of the foam rather than in the pores. When the samples were dipped in KOH solutions, much of the Ni(OH)₂ precipitated on the surface and came off during rinsing in H₂O. During formation, remaining surface deposits fell off with the net result being a loss of capacity and reduced loading.

Since carbon foam was found to have good affinity for organic solvents, a aqueous methanol nickel nitrate solution was prepared. This solvent appeared to penetrate the pore structure more effectively as higher loading was obtained. The loading improved to 1.1 g/cm³

Thermal Deposition

Mitsubishi and PocoFoam samples were deposited using the fused salt method. Both samples exhibited low loading values of 0.5-0.6 g/cc vv as the molten nickel nitrate deposited more on the surface of the carbon foam than in the inner pores. The surface deposits prevented any further interior deposition from taking place. During formation there was a further loss of Ni(OH)₂ as more material fell off.

### Example 8

SEM pictures of six different nickel electrodes were prepared to study the affect of the different deposition methods. Cross-sections (fractured surface) of these electrodes were examined to compare the extent of deposits in the inner pores. The SEM of the sample electrochemically deposited using nickel nitrate in 45% methanol showed deeper deposition within the foam structure. Also, the electrode deposited at a lower current density gave the best distribution and deposition of active mass in the foam pores. The thermally and chemically deposited electrodes show deposition mostly on the electrode surface.

### Example 9

IR spectroscopy was used to determine the structure of deposited nickel hydroxide and the effect deposition current had on the structure. Two electrodes having different current densities were studies. One electrode had a current density of 15 mA/cm² and the second electrode had a current density of 120 mA/cm².

An electrochemically deposited Ni(OH)₂ is a mixture of β-Ni(OH)₂ and α-Ni(OH)₂ phases. The percentage of each phase present in the active mass can be determined with FTIR spectroscopy. FTIR spectroscopy is based on the detection of vibrational modes due to lattice vibrations and molecular group vibrations. The α/β percentage can be determined from the FTIR spectrum because the absorbance of the active mass is proportional to the concentration of each phase (β-Ni(OH)₂ and α-Ni(OH)₂). For quantitative analysis of a deposited Ni(OH)₂ a standard spectrum of each pure phase is required.

The quantitative analysis of a spectrum is done using the non-negative least square method (NNLS) in the Excel™ Solver program. The method is used to fit the spectrum of the deposited Ni(OH)₂ as a linear combination of the β-Ni(OH)₂ and α-Ni(OH)₂ phase FTIR spectra. The percentage of the β-Ni(OH)₂ and α-Ni(OH)₂ phases calculated for two Ni(OH)₂ samples are shown in Table 7. An interesting variation in the α to β ratio as a function of current density used in the electrochemical deposition is observed. The higher current density sample contains more α-phase.

TABLE 7
Percent Composition of α- and β-Ni(OH)₂ for Two
Electrochemical Depositions Done at Low and High
Current Densities (45% Methanol, MB Foam)

| Deposited Ni(OH)₂ | α-Ni(OH)₂ | β-Ni(OH)₂ |
|---|---|---|
| High Current Density Ni(OH)₂ (120 mA/cm²) | 76 | 24 |
| Low Current Density Ni(OH)₂ (15 mA/cm²) | 36 | 64 |

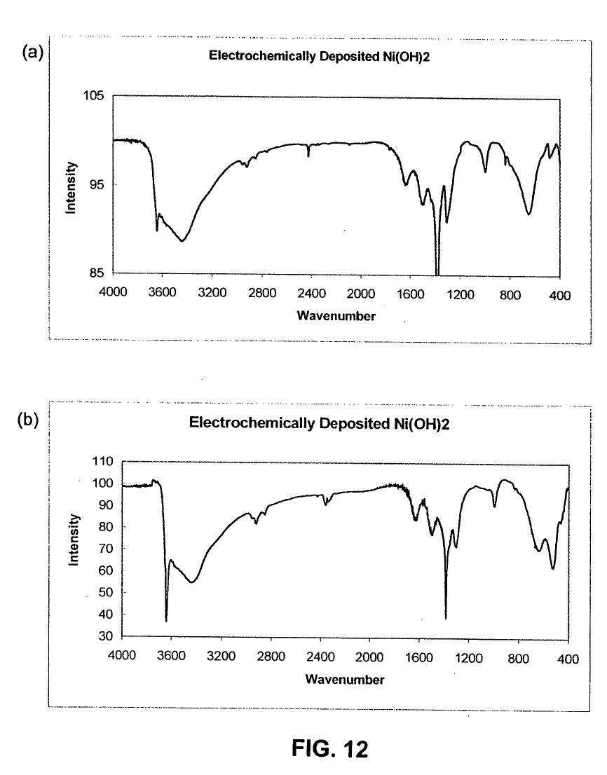

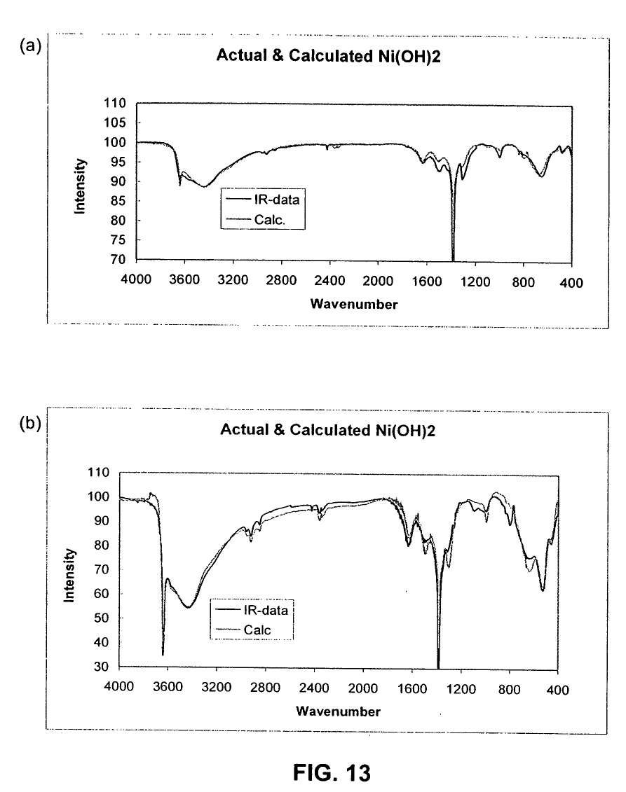

The IR spectra of the two electrochemically deposited Ni(OH)₂ phases are shown in FIG. 12. The best fit spectra calculated and actual experimental spectra were compared in FIG. 13. As evident from these spectra, the electrochemically deposited material was a mixture of the β-Ni(OH)₂ and α-Ni(OH)₂ phases. These spectra were fitted in the 4500-3000 cm⁻¹ and 1100-400 cm⁻¹ regions, ignoring the variable nitrate content exhibited between 3000 and 400 cm⁻¹.

Thus, the invention provides, among other things, a nickel hydroxide impregnated carbon foam electrode. The above examples demonstrate the superiority of the electrodes prepared using the methanol and ethanol wetting agents during the deposition process. Various features and advantages of the invention are set forth in the following claims.

What is claimed is:

1. An electrode comprising a porous monolithic carbonaceous substrate having an active mass deposited thereto.

2. The electrode of claim 1, wherein the carbonaceous substrate is graphitized.

3. The electrode of claim 1, wherein the carbonaceous substrate is amorphous.

4. The electrode of claim 1, wherein the substrate has pores about 1 to about 3,000 microns in diameter.

5. The electrode of claim 1, wherein the substrate has pores about 1 to about 1,000 microns in diameter.

6. The electrode of claim 1, wherein the active mass comprises at least one of nickel hydroxide, nickel oxyhydroxide, and a combination thereof.

7. The electrode of claim 1, wherein the active mass comprises nickel hydroxide having a loading level of about 0.5 to about 1.8 g active mass/cm³ void volume of substrate (g/cm³ vv).

8. The electrode of claim 6, wherein the active mass further comprises an additive.

9. The electrode of claim 8, wherein the additive comprises at least one transition metal, lanthanide group metal, and combination thereof.

10. The electrode of claim 8, wherein the additive is present in a concentration of about 0.1 to about 35 mole percent of cation sites.

11. The electrode of claim 8, wherein the additive is present in a concentration of about 1 to about 25 mole percent of cation sites.

12. The electrode of claim 8, wherein the additive comprises at least one of Li, K, Fe, Zn, Co, Mn, Al, Zr, Y, and La.

13. The electrode of claim 1, wherein the active mass comprises Ni_{(1-w-x-y)}M_{w}(nH)ₓK_{y}OOH_{(2-z)} wherein (x+y)≦0.25, x≦0.25, y≦0.25, n≦4, w≦0.5, z≦2, and M=a transition metal, a lanthanide group metal, and a combination thereof.

14. A method of making an electrode comprising:
producing a coated substrate by depositing an active mass onto a porous monolithic carbonaceous substrate, wherein the active mass comprises at least one of nickel hydroxide, nickel oxyhydroxide, and a combination thereof; and
activating the active mass by cyclically charging and discharging the coated substrate in an electrolytic solution.

15. The method of claim 14, wherein the active mass further comprises an additive.

16. The method of claim 15, wherein the additive comprises at least one transition metal, lanthanide group metal, and combination thereof.

17. The method of claim 15, wherein the additive comprises at least one of Li, K, Fe, Zn, Co, Mn, Al, Zr, Y and La.

18. The method of claim 14, wherein the carbonaceous substrate is graphitized.

19. The method of claim 14, wherein the carbonaceous substrate is amorphous.

20. The method of claim 14, wherein prior to producing the coated substrate, the substrate has an electrical resistivity less than about 10,000 ohm-cm.

21. The method of claim 14, wherein the active mass is cyclically charged and discharged about 5 to about 200 cycles.

22. The method of claim 14, wherein the electrolyte comprises KOH.

23. The method of claim 14, wherein the coated substrate is charged at a rate of about 15 to about 120 mA/cm² for each cycle and discharged to a voltage of about 1 to about 0 V (vs. SCE reference electrode) for each cycle.

24. The method of claim 14, wherein producing the coated substrate comprises:
(a) dipping the substrate into a nickel(II) salt solution comprising water and a wetting agent;
(b) dipping the substrate into an alkaline solution; and
(c) repeating steps (a) and (b) until deposits appear on one or more surfaces of the substrate.

25. The method of claim 24, wherein the nickel(II) salt solution is maintained at a temperature of about 20 to about 80° C. and comprises about 35% to about 55% by volume wetting agent.

26. The method of claim 24, wherein the nickel(II) salt solution comprises about 1 M to about 2 M nickel nitrate and the alkaline solution comprises about 10 to about 45% by weight potassium hydroxide.

27. The method of claim 14, wherein producing the coated substrate comprises:
(a) heating the substrate to about 200° C.;
(b) dipping the heated substrate into molten Ni(NO₃)₂.6H₂O;
(c) removing the substrate from the molten Ni(NO₃)₂.6H₂O and heating the substrate to about 200° C.;
(d) repeating steps (b) and (c) until green deposits appear on one or more surfaces of the substrate; and
(e) placing the substrate with deposits on one or more surfaces in an about 10% to about 45% by weight solution of KOH.

28. The method of claim 14, wherein producing the coated substrate comprises:
(a) making an electrochemical cell having a cathode comprising the substrate, an anode counter electrode, and an electrolyte comprising nickel(II) in a solution of water and a wetting agent; and
(b) applying a current across the cell to deposit active mass onto the substrate.

29. The method of claim 28, wherein the electrolyte comprises about 35% to about 55% by weight wetting agent.

30. The method of claim 28, wherein the electrolyte comprises from about 1 M to about 2 M Ni(NO₃)₂ and from about 35% to about 55% by weight alcohol.

31. The method of claim 30, wherein the alcohol comprises at least one of methanol, ethanol and combination thereof.

32. The method of claim 28, wherein step (a) further comprises maintaining the pH of the nickel nitrate solution at about 2.5 to about 3.5.

33. The method of claim 28, wherein step (b) comprises operating the cell at a constant temperature in the range of about 40 to about 70° C., at a constant current in the range of about 55 to about 80 mA/cm², and for a duration of about 150 to about 240 minutes.

34. The method of claim 14, wherein producing the coated substrate comprises:
(a) making an electrochemical cell having a cathode comprising the substrate, an anode counter electrode, and an electrolyte comprising nickel(II) in a solution of water and sodium nitrite; and
(b) applying a current across the cell to deposit active mass onto the substrate.

35. A battery comprising:
a cathode having a porous monolithic carbonaceous substrate attached to a current collector and coated with an active mass;
a second electrode comprising a metal; and
an electrolyte.

36. The battery of claim 35, wherein the carbonaceous substrate is graphitized.

37. The battery of claim 35, wherein the carbonaceous substrate is amorphous.

38. The battery of claim 35, wherein the active mass comprises at least one of nickel hydroxide, nickel oxyhydroxide, and a combination thereof.

39. The battery of claim 38, wherein the active mass further comprises an additive

40. The battery of claim 39, wherein the additive comprises at least one transition metal, lanthanide group metal, and combination thereof.

41. The battery of claim 39, wherein the additive is present in a concentration of about 1 to about 25 mole percent of cation sites.

42. The battery of claim 39, wherein the additive comprises at least one of Li, K, Fe, Zn, Co, Mn, Al, Zr, Y, and La.

43. The battery of claim 35, wherein the active mass comprises Ni_{(1-w-x-y)}M_{w}(nH)ₓK_{y}OOH_{(2-z)}, wherein (x+y)≦0.25, x≦0.25, y≦0.25, n≦4, w≦0.5, z≦2, and M=a transition metal, a lanthanide group metal, and combination thereof.

44. The battery of claim 35, wherein the second electrode comprises cadmium, iron, zinc, manganese, hydrogen or a metal hydride.
